(19) United States
(12) Patent Application Publication
(10) Pub. No.: US 2007/0125247 A1
(43) Pub. Date: Jun. 7, 2007

(54) Method and apparatus for coating of implants

(76) Inventors: Jürgen Kunstmann, Bad Soden (DE); Bernhard Mayer, Mainz (DE); Jorg Rathenow, Eppstein (DE); Soheil Asgari, Wiesbaden (DE)

Correspondence Address: DORSEY & WHITNEY LLP;INTELLECTUAL PROPERTY DEPARTMENT, 250 PARK AVENUE, NEW YORK, NY, 10177, US

(21) Appl. No.: 10/578,816

(22) PCT Filed: Nov. 3, 2004
(86) PCT No.: PCT/EP04/12442

§ 371 Date: Jan. 31, 2007

(30) Foreign Application Priority Data
Nov. 3, 2003 (DE) 103 51 150.4

(51) Int. Cl. B41M 1/10

(52) U.S. Cl. 101/170

(57) ABSTRACT

The present invention relates to a method and a device for applying a defined amount of a coating material onto the surface of an implant by means of a printing process, in particular using a printing roller. The invention also relates to the use of a printing process, in particular a printing roller, for applying a defined amount of a coating material onto the surface of the implant to be coated and to correspondingly produce coated implants.

### CROSS REFERENCE TO RELATED APPLICATION(S)

This application is a national stage application of PCT Application No. PCT/EP2004/012442 which was filed on Nov. 3, 2004 and published on May 12, 2005 as International Publication No. WO 2005/042045 (the “International Application”), the entire disclosure of which is incorporated herein by reference. This application claims priority from the International Application pursuant to 35 U.S.C. § 365. The present application also claims priority under 35 U.S.C. § 119 from German Patent Application No. 103 52 150.4, filed Nov. 3, 2003, the entire disclosure of which is incorporated herein by reference.

### FIELD OF THE INVENTION

The present invention relates to a method and apparatus for applying a defined amount of a coating material onto the surface of an implant using a printing technique or arrangement, such as a printing roller.

### BACKGROUND INFORMATION

In order to reduce a body's own defense reactions against foreign implants or to avoid them as much as possible, coated implants are being increasingly used in the field of medicine. Coated implants may improve the biological compatibility of the implant materials used, permit a better integration into the surrounding tissue, and/or “camouflage” the material of the implant that is foreign to the body with respect to the immune system. Moreover, implants coated or impregnated with pharmacologically effective substances are being increasingly used. Such coated implants can allow a targeted release of the active substances locally at the site of the implant.

A number of processes for coating implants have been developed. Conventional methods that generally apply coatings onto implants include, for example, brush application, varnishing, dipping and similar processes.

Coating of medical implants having a complex form such as, e.g., coronary stents, joint prostheses and surgical implants can require a high accuracy with respect to the quantity of the coating and/or the coating material to be applied. Accuracy of a coating process can be important if medicinally active substances are applied, and it can also be important with respect to the quality and durability of the coating.

Dipping or dip impregnation processes are frequently used. These processes have the disadvantage that an exact quantity of a pharmacologically active agent absorbed depends to a large extent on the absorption or adsorption characteristics and the coating conditions chosen. This makes an accurate determination of the quantity of pharmacologically active agent actually applied in the coating difficult to achieve. The quantity applied may also be subject to process-related variations. Thus, there can be a discrepancy between the theoretical and the actual absorption capacity of porous implant surfaces for each individual active agent to be applied. This discrepancy can be significant in some cases.

German Patent Application DE 198 49 467 describes how stents coated with carrier polymers can be derivatized with cyclodextrins into which pharmacologically active agents can then be incorporated. The amount of the cyclodextrins applied on the surface determines the absorbable amount of the active agent in a reproducible manner. For example, the maximum dose of the active agent to be absorbed into the coating can thus be determined accurately. A disadvantage of this process, however, stems from a requirement therein that the surface of the stents may need to be coated with a carrier polymer that is capable of binding cyclodextrins. Moreover, measurements can be required for this process, following the manufacture of the cyclodextrin-derivatized stent surface, to determine the exact absorption capacity of the cyclodextrin portion for pharmacologically active agents. An introduction of active agents into the cyclodextrins can lead to discrepancies, as with other absorptive systems, between the theoretical and actual absorption capacity as a function of the active agents used.

In view of the inaccuracies of the dosage of active principles that may arise when coating medical implants according to conventional processes, there may be a need to provide simple and robust coating methods which may permit application of an accurate dosage of active agents when coating foreign bodies such as, e.g., medical implants.

### OBJECTS AND SUMMARY OF EXEMPLARY EMBODIMENTS OF THE INVENTION

It is one of the objects of the present invention to provide a method for applying a coating material onto the surface of any desired implant, which facilitates, e.g., an exact control of the amount of the coating material applied.

Another object of the present invention is to provide a method which facilitates that implants can be coated singly or multiply, i.e. with one or several layers of one or different coating materials in, e.g., an exact and reproducible manner.

A further object of the present invention includes providing an apparatus for carrying out the method in accordance with exemplary embodiments of the present invention.

According to one exemplary embodiment of the present invention, a method and apparatus are provided for applying a defined amount of a coating material onto a medical implant. The coating material can be provided in the form of, e.g., a suspension, an emulsion, a solution, a powder, etc. The coating material can first be provided in recesses located in the surface of a printing roller such as, e.g., a printing roller. The printing roller can then be arranged relative to the implant so that adsorption and/or adhesion forces related to the implant surface can attract the coating material. A relative motion between the printing roller and the implant can then be performed to transfer the pre-defined amount of the coating material contained in the recesses onto the implant. The printing roller can be in direct contact with the implant during this transfer, or it may be in close proximity but not in direct contact. This relative motion can be performed by rotating the printing roller and the implant around axes that are approximately parallel to each other. The motion between the printing roller and the implant can optionally be slip-free. The coating material can be provided in the recesses, e.g., by first applying an excess amount of the coating material onto the printing roller, filling the recesses, and then scraping off the excess material using, e.g., a slitter bar or a flat edge to scrape off the excess coating material protruding beyond the outer surface of the printing roller. The coating material can optionally be provided to the printing roller by using, e.g., a scoop roller. The scoop roller can be arranged so that at least a portion of it is in contact with a supply of the coating material which may be held, e.g., in a container or a reservoir. The scoop roller and the printing roller can be moved with respect to each other so that the coating material may be transferred to the recesses in the surface of the printing roller.

According to another exemplary embodiment of the present invention, the coating material may include a pharmacologically effective substance or a precursor to a pharmacologically effective substance. The coating material may include micro-organisms, living cells, biocompatible organic or inorganic substances, or combinations thereof. The pharmacologically effective substances or precursors may be encapsulated, e.g., in nanoparticles, microcapsules, liposomes, micelles, emulsions, etc.

In a further exemplary embodiment of the present invention, the implant may be coated with more than one layer of the coating material. Different coating materials may be used to form different coated layers. Outer coated layers can include substances that are capable of modifying the release rate of further substances contained in inner coated layers when placed in a suitable environment, such as within a human or animal body.

In still further exemplary embodiments of the present invention, coated implants may be provided that may be produced using the exemplary methods described above. The implants can have the form of, e.g., a stent, a prosthesis, an orthopedic implant, an artificial heart valve, a pacemaker, etc.

According to another exemplary embodiment of the present invention, an apparatus may be provided that is capable of coating an implant with a predetermined amount of one or more coating materials. The apparatus can include a printing roller, where the surface of the roller may have a number of recesses of known size, or where it may optionally be smooth. The apparatus can also include a reservoir or container to hold a quantity of the coating material, and it may optionally include level sensors that can be provided to maintain an amount of coating material that is between predefined levels. The apparatus may further include, e.g., a scoop roller that can be configured to transfer the coating material from the reservoir to the printing roller, and an optional slitter bar or other edge that can scrape any excess coating material off of the printing roller, thus allowing a predetermined amount of coating material held in the recesses to be transferred to the implant. The apparatus may include one or more motors or other devices configured to move the implant and printing roller and, optionally, the scoop roller, relative to each other to allow transfer of the coating material.

These and other objects, features and advantages of the present invention will become apparent upon reading the following detailed description of embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1A is a schematic illustration of an exemplary apparatus configured to apply a coating in accordance with exemplary embodiments of the present invention; and

FIG. 1B is a schematic illustration of a side view of the exemplary apparatus shown in FIG. 1A.

### DETAILED DESCRIPTION OF EXEMPLARY EMBODIMENTS OF INVENTION

According to an exemplary embodiment of the present invention, a method can be provided for applying a defined amount of a coating material onto a surface of an implant to be coated by means of a printing technique. In this exemplary method, recesses formed in a jacket surface of a printing roller can be charged with a pre-defined amount of the coating material. The printing roller can be arranged with respect to the implant to be coated in such a way that adsorption and/or adhesion forces which are intrinsic to the surface properties of the implant to be coated are capable of being attracted to the coating material present in the recesses of the jacket surface of the printing roller. Further, the coating material present in the recesses of the jacket surface of the printing roller can be applied by moving the jacket surface of the printing roller and the surface of the implant to be coated with respect to each other.

An apparatus that can be provided in accordance with exemplary embodiments of the present invention may include a device for applying a defined quantity of a coating material onto the surface of an implant to be coated using a printing roller. A number of recesses that may have been formed in a jacket surface of the roller are capable of holding a defined quantity of coating material. The printing roller can be positioned with respect to the implant to be coated in such a way that the suction and/or adsorption forces which may be intrinsic to the surface properties of the implant to be coated are capable of attracting the coating material present in the recesses of the jacket surface of the printing roller. This can permit the application of the coating material present in the recesses of the jacket surface of the printing roller onto the surface of the implant to be coated by moving the jacket surface of the printing roller and the surface of the body to be coated with respect to each other. Preferably, this moving procedure can occur in an essentially slip-free manner. It has been found that printing processes are particularly suitable for applying coating materials onto the surface of an implant to be coated in a defined and accurately metered manner.

Preferably, printing rollers with a defined surface structure may be used which exhibit recesses in the jacket surface of the printing roller. Such surfaces can allow, e.g., a precise determination of the volume of coating material held per unit area of the printing roller surface.

The term “printing roller” may be understood to include any printing roller having a jacket surface which contains numerous recesses of defined geometry and arrangement. The recesses in the jacket surface of the printing roller may have any desired three-dimensional geometrical forms such as, e.g., small cups, groove structures, pointed pyramids, flat pyramids, grids, semi-spherical grids, cylinder-shaped recesses, etc.

Recesses formed in the jacket surface of the printing roller make it possible, as a result of their known dimensions, to accurately determine the volume of a coating material which is being applied onto the printing roller, based on the surface area of the jacket surface of the printing roller. The recess volume per unit area of the jacket surface of the printing roller can thus provide, e.g., a precise measure of the maximum dosage of the coating material which can be released by applying the coating material present in the recesses of the jacket surface of the printing roller onto the surface of the implant to be coated.

In this manner, it is possible to accurately determine the maximum amount of coating material which can be transferred onto the surface of the implant by moving the implant along the jacket surface of the printing roller or by moving the printing roller along the surface of the implant to be coated. By repeatedly moving the jacket surface of the printing roller and/or the surface of the implant to be coated with respect to one another, the total amount of the applied coating material can be increased as desired.

Printing rollers suitable for use in accordance with exemplary embodiments of the present invention can include, e.g, gravure rollers, anilox rollers, rotogravure rollers, ceramic rollers, ceramic anilox rollers, ceramic-coated anilox rollers, flexographic printing rollers, embossing rollers, calendar rollers, and other printing rollers having jacket surfaces that exhibit recesses for receiving coating material. Anilox rollers may preferably be used with certain exemplary embodiments of the present invention.

According to a further exemplary embodiment of the present invention, rollers without recesses may be utilized. For example, the rollers can have a smooth surface structure onto which the coating material may be applied using suitable processes in a defined layer thickness. Conventional processes exist for charging printing rollers with defined layer thicknesses of coating material. The benefits described herein in connection with printing rollers containing recesses can apply, with certain modifications as needed, to rollers that do not have recesses and to application methods carried out therewith.

The coating thickness on the printing roller free from recesses can be adjusted by conventional methods such as, for example by using precision spray technology or ultrasound atomisation methods to generate finely distributed and homogenous spray images.

In accordance with exemplary embodiments of the present invention, the recesses formed in the jacket surface of the printing roller or the jacket surface of a roller itself can first be charged with a defined amount of the coating material. This can be achieved in several ways that may depend on the state of aggregation of the coating material such as, for example, by partially or completely dipping the surface of the printing roller into liquid or powdery coating materials, by spraying liquid, dissolved or powdery coating materials onto the surface of the printing roller, etc. In preferred exemplary embodiments, powdery coating materials can also be applied onto the jacket surface and into the recesses by electrostatic attraction.

In order to adjust the volume of the coating material located in the recesses of the jacket surface of the printing roller as accurately as possible, excess coating material may be applied and then removed from the jacket surface. This can be achieved by using a slitter bar or similar device to scrape off excess material held in the recesses that rises above the surface of the roller back to the level of the roller surface.

An accurate, reproducible dosage of the substance to be applied can also be achieved by utilizing a fine pattern of recesses and their anilox formation. In preferred embodiments of the process in accordance with exemplary embodiments of the present invention, the top surface of the recesses may be smaller than the surface of the implant to be coated. The ratio of the top surface area of the recesses in the printing roller to the surface area of the implant to be coated may be about 1:10, or preferably about 1:100, or more preferably about 1:1000, or about 1:5000 or 1:10000 or more.

The use of gravure rollers or anilox rollers, including ceramic anilox rollers or ceramic-coated anilox rollers or the use of metal gravure rollers, including those made of stainless steel, may be preferred. Moreover, gravure and/or anilox rollers made of steel, which may be chromium-plated, or stainless steel, can be particularly preferred rollers. In certain exemplary embodiments, stainless steel anilox or gravure rollers or chromium-plated steel anilox rollers with a pattern of, e.g., 120, 240, or up to about 300 recesses in each direction, i.e., 120×120, 240×240 or 300×300 recesses per cm³ of the printing roller jacket surface, may be used. The volume of each recess can be about 1×10⁻⁶ to 1×10⁻⁴ mm³. This volume can be selected to be larger or smaller based on the desired application by using, e.g., a more or less dense pattern of recesses, deeper or shallower recesses, and/or larger or smaller recesses. The recess volume of a stainless steel anilox roller suitable for use according to the invention may be approximately 2×10⁻⁵ mm³ with a 240×240 pattern.

Ceramic anilox rollers or ceramic-coated anilox rollers may have preferred pattern densities of about 120, 450, or up to about 700 recesses in each direction, with individual recess volumes of about 1×10⁻⁷ mm³ to 1×10⁻⁴ mm³ each, or preferably about 5.7×10⁻⁶ mm³ each, wherein larger or smaller recess volumes may be selected based on the desired application, by using, e.g., a more or less dense pattern of recesses, deeper or shallower recesses, and/or larger or smaller recesses.

In accordance with an exemplary embodiment of the present invention, charging of the recesses formed in the jacket surface of the printing roller with a coating material can be achieved using a rotating scoop roller (e.g., a “fountain roller”), wherein at least one cylinder segment of the scoop roller can be continually present in a coating material bath during rotation. The scoop roller may thus be wetted circumferentially with coating material, and transfer the coating material thus received subsequently onto the printing roller. Preferably, the scoop roller can touch the printing roller during this procedure such that excess coating material can be squeezed off from the surface of the printing roller. The surface of the scoop roller can optionally be modified to include a slitter bar or the like.

A printing roller charged with coating material in a defined quantity may be arranged with respect to an implant in such a way that the adsorption and/or adhesion forces which may be intrinsic to the surface properties of the implant can attract the coating material present in the recesses of the jacket surface of the printing roller. In this manner, the coating material can be removed from the recesses of the printing roller jacket surface and attached and/or fixed onto the surface of the implant to be coated, or absorbed into a pore system of a porous implant surface.

In accordance with certain exemplary embodiments of the present invention, positioning of the charged printing roller with respect to the implant to be coated is performed such that a direct contact is established between the implant and the printing roller.

According to further exemplary embodiments of the present invention, positioning of the charged printing roller with respect to the implant to be coated can be performed without direct contact between them. The printing roller and the implant to be coated can approach each other sufficiently closely such that the volumes of coating material present in the recesses of the jacket surface of the printing roller can pass from the printing roller onto the implant to be coated. This procedure may transfer, e.g., essentially all of the coating material in the recesses to the surface of the implant. The geometry for such a contact-free application process may be selected as a function of the specific properties of the coating material used and the surface properties of the implant.

For liquid coating materials, distances between the printing roller and the implant may be about 1 μm to 10 mm, or preferably about 100 μm.

To apply the coating material present in the recesses of the jacket surface of the printing roller, it may be preferable that the movement between the jacket surface of the printing roller and the surface of the implant to be coated occur in a slip-free manner. The process according to exemplary embodiments of the present invention can be carried out in such a way that the surface of the implant to be coated is moved in a slip-free manner along the jacket surface of the printing roller or, alternatively, that the jacket surface of the printing roller is moved in a slip-free manner along the surface of the implant to be coated. A preferably slip-free counter-movement between the jacket surface of the printing roller and the surface of the implant to be coated may also be utilized, and can be particularly preferred in certain exemplary embodiments of the present invention.

If the relative motion of the jacket surface of the printing roller and the surface of the body to be coated is not performed in a slip-free manner, the conditions of the transfer of coating material from the printing roller onto the implant cam be adjusted in such a way that a reproducible amount of coating material is transferred during the movement process. For liquid coatings, the hydrodynamic conditions should be adjusted appropriately.

In a further exemplary embodiment of the present invention, the implant to be coated may have a cylindrical form. The relative movement of the jacket surface of the printing roller and the surface of the implant to be coated, which may be preferably slip-free, can thus occur in a manner in which the printing roller and the implant to be coated are rotated in opposite directions around two axes that are approximately parallel to each other.

If the implant to be coated has a non-cylindrical geometry, the preferably slip-free movement of the jacket surface of the printing roller relative to the surface of the implant to be coated can occur such that the axis of the printing roller is moved in an equidistant manner along the surface of the implant to be coated. In this way, a quasi-scanning of the surface of the implant to be coated by the charged roller can be achieved.

The implant to be coated can have any desired form, provided that the details of the method are adjusted accordingly. Various arrangements of the printing roller and the charging system for the recesses in the jacket surface of the printing roller may be select as preferred.

The term “implant” can be understood to include, in general, medical, diagnostic and therapeutic implants such as, e.g., vascular endoprostheses, intraluminal endoprostheses, stents, coronary stents, peripheral stents, surgical and/or orthopaedic implants for temporary purposes such as surgical screws, plates, nails and other fixing means, permanent surgical or orthopaedic implants such as bone or joint prostheses, e.g., artificial hip or knee joints, joint cavity inserts, screws, plates, nails, implantable orthopaedic fixing means, vertebral body substitutes, as well as artificial hearts and parts thereof, artificial heart valves, pacemaker housings, implants for percutaneous, subcutaneous and/or intramuscular use, slow release active principles, microchips, etc. which are intended to be used in a human or animal body and/or are intended for application on or in a human or animal body.

In accordance with certain exemplary embodiments of the present invention, the implant to be coated may include medical, diagnostic or therapeutic implants such as vascular endoprostheses, stents, coronary stents, peripheral stents, orthopaedic implants, bone or joint prostheses, artificial hearts, artificial heart valves, pacemaker electrodes, subcutaneous, percutaneous and/or intramuscular implants, surgical nails, screws, fixing agents, pins, etc. However, any desired body form may be coated by using the method and apparatus of the present invention, wherein the method may be characterized by an applied quantity of the coating material that can be determined and predetermined accurately.

In accordance with another embodiment of the present invention, the implant to be coated may be a stent, which may have a generally cylindrical form, particularly preferably a carbon-coated stent. Such an exemplary stent is described, for example, in German Patent Application No. DE 103 33 098, and may be manufactured according to the method described therein.

The implants, which can be reproducibly coated using the exemplary embodiments of the present invention, can be made of almost any desired material, including materials which may be generally used to form implants. Examples of such materials may include amorphous and/or (partially) crystalline carbon, bulk carbon material, porous carbon, graphite, carbon composite materials, carbon fibers, plastics, polymer material, synthetic resin fibers, ceramics such as, e.g., zeolites, silicates, aluminum oxides, aluminosilicates, silicon carbide, silicon nitride; metal carbides, metal oxides, metal nitrides, metal carbonitrides, metal oxycarbides, metal oxynitrides and metal oxycarbonitrides of the transition metals such as titanium, zirconium, hafnium, vanadium, niobium, tantalum, chromium, molybdenum, tungsten, manganese, rhenium, iron, cobalt, nickel; metals and metal alloys, in particular of the noble metals gold, silver, ruthenium, rhodium, palladium, osmium, iridium, platinum; metals and metal alloys of titanium, zirconium, hafnium, vanadium, niobium, tantalum, chromium, molybdenum, tungsten, manganese, rhenium, iron, cobalt, nickel, copper; steel, in particular stainless steel, shape retention alloys such as nitinol, nickel-titanium alloy, glass, stone, glass fibers, minerals, natural or synthetic bone substance, bone imitates based on alkaline earth metal carbonates such as calcium carbonate, magnesium carbonate, strontium carbonate, and any desired combinations of the above-mentioned materials.

Depending on the coating material to be applied, the implant to be coated can be formed of any desired substances provided the material is able to absorb and/or bind the coating material or fix it at the surface.

Preferred materials from the field of medical, diagnostic or therapeutic implants which can be used to form an implant and be coated in accordance with exemplary embodiments of the present invention include, for example, carbon, carbon fibers, bulk carbon material, carbon composite material, carbon fiber, plastics, polymer material, synthetic resin fibers, ceramic, glass or glass fibers, metals such as stainless steel, titanium, tantalum, platinum; alloys such as nitinol, nickel-titanium alloy; bone, stone, mineral, or combinations of these materials. If necessary, the implants to be coated that are formed of the above-mentioned materials may first be coated with one or several layers of one or several of the above-mentioned materials.

The coating material for use in exemplary embodiments of the present invention can be in a form of a solution, suspension or emulsion of one or several active agents or active agent precursors in a suitable carrier material, an undiluted liquid active agent, or one or several active agents and/or active agent precursors in powder form.

The term “active agent” can be understood to include pharmacologically effective substances such as medicines, medicaments, pharmaceuticals, micro-organisms, living organic cell material, and/or enzymes, as well as biocompatible inorganic or organic substances. The term “active agent precursors” can be understood to refer to substances or mixtures of substances which, after application onto an implant to be coated, may be converted by thermal, mechanical, chemical and/or biological processes into active agents such as those mentioned above.

Organic active agents or active agent precursors that can be used in the coating materials in accordance with exemplary embodiments of the present invention can include, e.g., biodegradable and/or resorbable polymers such as collagen, albumin, gelatin, hyaluronic acid, starch, celluloses such as methylcellulose, hydroxypropyl cellulose, hydroxypropyl methylcellulose, carboxymethylcellulose phthalate, casein, dextrans, polysaccharides, fibrinogen, poly(D,L-lactides), poly(D,L-lactide coglycolides), poly(glycolides), poly(hydroxybutylates), poly(alkyl carbonates), poly(orthoesters), polyesters, poly(hydroxyvaleric acid), polydioxanones, poly(ethyl enterephthalates), poly(malatic acid), poly(tartronic acid), polyanhydrides, polyphosphazenes, poly(amino acids), and their copolymers, or non-biodegradable and/or resorbable polymers. Anionic, cationic or amphoteric coatings such as alginate, carrageenan, carboxymethylcellulose; chitosan, poly-L-lysine; and/or phosphoryl choline may be particularly preferred.

Active agents or active agent precursors that can be used as coating material can also include, e.g., markers, contrast agents or the like which can be used to locate coated implants in the body as well as, e.g., therapeutic or diagnostic amounts of radioactive sources of radiation and the like.

In certain exemplary embodiments of the present invention, e.g., when using subcutaneous/intramuscular active agent depots or stents, the charge of active agent can also be temporary, i.e., the active agent may be released after implanting of the implant, or the active agent may be immobilized permanently in or on the implant. In this manner, medical implants containing active agents can be produced with static, dynamic or combined static and dynamic charges of active agents. Thus, multifunctional coatings may be obtained on the implants coated in accordance with exemplary embodiments of the present invention.

When static charging is used with active agents, the active agents may be essentially permanently immobilised on the implant. Active agents suitable for use for this purpose can include biocompatible inorganic substances such as, e.g., hydroxyl apatite (HAP), fluoroapatite, tricalcium phosphate (TCP), zinc; and/or organic substances such as, e.g., peptides, proteins, carbohydrates such as monosaccharides, oligosaccharides and polysaccharides, lipids, phospholipids, steroids, lipoproteins, glycoproteins, glycolipids, proteoclycanes, DNA, RNA, signal peptides or antibodies or antibody fragments, bioresorbable polymers, e.g., polylactonic acid, chitosan and pharmacologically effective substances or mixtures of such substances and combinations thereof.

When dynamic charging is used with active agents, the applied active agents should be released after inserting the implant in the body. In this way, it is possible to use the coated implants for therapeutic purposes, wherein the active agents applied onto the implant are released locally, successively at the site of use of the implant. The active agents suitable for use in dynamic charges of active agents for release of active agents include, for example, hydroxyl apatite (HAP), fluoroapatite, tricalcium phosphate (TCP), zinc; and/or organic substances such as peptides, proteins, carbohydrates such as monosaccharides, oligosaccharides and polysaccharides, lipids, phospholipids, steroids, lipoproteins, glycoproteins, glycolipids, proteoglykanes, DNA, RNA, signal peptides or antibodies or antibody fragments, bioresorbable polymers, e.g., polylactonic acid, chitosan and the like, and pharmacologically effective substances or mixtures of such substances.

Suitable pharmacologically effective substances or mixtures of substances for static and/or dynamic charging of implants coated in accordance with exemplary embodiments of the present invention can comprise active agents or active agent combinations which may include heparin, synthetic heparin analogues (e.g., fondaparinux), hirudin, antithrombin III, drotrecogin alpha; fibrinolytics such as alteplase, plasmin, lysokinases, factor XIIa, prourokinase, urokinase, anistreplase, streptokinase; thrombocyte aggregation inhibitors such as, e.g., acetyl salicylic acid, ticlopidins, clopidogrel, abciximab, dextrans; corticosteroids such as alclometasones, amcinonides, augmented betamethasones, beclomethasones, betamethasones, budesonides, cortisones, clobetasol, clocortolones, desonides, desoximetasones, dexamethasones, flucinolones, fluocinonides, flurandrenolides, flunisolides, fluticasones, halcinonides, halobetasol, hydrocortisones, methyl prednisolones, mometasones, prednicarbates, prednisones, prednisolones, triamcinolones; so-called non-steroidal anti-inflammatory drugs such as diclofenac, diflunisal, etodolac, fenoprofen, flurbiprofen, ibuprofen, indomethacin, ketoprofen, ketorolac, meclofenamate, mefenamic acid, meloxicam, nabumethones, naproxen, oxaprozin, piroxicam, salsalates, sulindac, tolmetin, celecoxib, rofecoxib; cytostatics such as alkaloids and podophyllum toxins such as vinblastin, vincristin; alkylants such as nitroso ureas, nitrogen dichlorodiethyl sulphide analogues; cytotoxic antibiotics such as, e.g., daunorubicin, doxorubicin and other anthracyclins and allied substances, bleomycin, mitomycin; antimetabolites such as folic acid, purine analogues or pyrimidine analogues; paclitaxel, docetaxel, sirolimus; platinum compounds such as carboplatin, cisplatin or oxaliplatin; amsacrin, irinotecan, imatinib, topotecan, interferon-alpha 2a, interferon-alpha 2b, hydroxycarbamide, miltefosin, pentostatin, porfimer, aldesleukin, bexarotene, tretinoin; antiandrogens and antiestrogens; antiarrythmics, in particular antiarrhythmics of class I such as, e.g., antiarrhythmics of the quinidine type, e.g., quinidine, dysopyramid, ajmalin, prajmalium bitartrate, detajmium bitartrate; antiarrhythmics of the lidocain type, e.g., lidocain, mexiletin, phenytoin, tocainid; antiarrhythmics of class IC, e.g., propafenon, flecainid (acetate); antiarrhythmics of class II, beta-receptor blockers such as metoprolol, esmolol, propranolol, metoprolol, atenolol, oxprenolol; antiarrhythmics of class III such as amiodaron, sotalol; antiarrhythmics of class IV such as, e.g., diltiazem, verapamil, gallopamil; other antiarrhythmics such as, e.g., adenosine, orciprenaline, ipratropium bromide; agents for stimulating angiogenesis in the myocardium such as, e.g., vascular endothelial growth factor (VEGF), basic fibroblast growth Factor (bFGF), non-viral DNA, viral DNA, endothelial growth factors; FGF-1, FGF-2, VEGF, TGF; antibodies, monoclonal antibodies, anticalines; stem cells, endothelial progenitor cells (EPC); digitalis glycosides such as, e.g., acetyl digoxin/methyl digoxin, digitoxin, digoxin; heart glycosides such as ouabain, proscillaridin; antihypertonics such as centrally acting anti-adrenergic substances e.g., methyl dopa, imidazoline receptor agonists; calcium channel blockers of the dihydropyridine-type such as nifedipine, nitrendipine; ACE blockers: quinaprilat, cilazapril, moexipril, trandolapril, spirapril, imidapril, trandolapril; angiotensin-II antagonists; candesartan cilexetil, valsartan, telmisartan, olmesartan medoxomil, eprosartan; peripherally effective alpha-receptor blockers such as, e.g., prazosin, urapidil, doxazosin, bunazosin, terazosin, indoramin; vasodilators such as, e.g., dihydralazin, diisopropyl amine dichloroacetate, minoxidil, nitroprussid sodium; other antihypertonics such as, e.g., indapamid, co-dergocrinmesilate, dihydroergotoxin methane sulphonate, cicletanin, bosentan, fludrocortisone; phosphodiesterase inhibitors such as, e.g., milrinon, enoximon and antihypotonics such as, in particular, adrenergic and dopaminergic substances such as, e.g., dobutamine, epinephrine, etilefrine, norfenefrine, norepinephrine, oxilofrine, dopamine, midodrine, pholedrine, amexinium methyl; and partial adrenoreceptor agonists such as, e.g., dihydroergotamin; fibronectin, polylysines, ethylene vinyl acetates, inflammatory cytokines such as TGFβ, PDGF, VEGF, bFGF, TNFα, NGF, GM-CSF, IGF-a, IL-1, IL-8, IL-6, growth hormones; as well as adhesive substances such as, e.g., cyanacrylates, beryllium, silica; and growth factors such as, e.g., erythropoietin, hormones such as, e.g., corticotrophins, gonadotropins, somatropin, thyrotrophin, desmopressin, terlipressin, oxytocin, cetrorelix, corticorelin, leuprorelin, triptorelin, gonadorelin, ganirelix, buserelin, nafarelin, goserelin and regulatory peptides such as somatostatin, octreotid; bone and cartilage stimulating peptides, so-called “bone morphogenic proteins” (BMPs), in particular recombinant BMPs such as e.g., recombinant human BMP-2 (rhBMP-2), bisphosphonate (e.g., risedronates, pamidronates, ibandronates, zoledronic acid, clodronic acid, etidronic acid, alendronic acid, tiludronic acid), fluorides such as disodium fluorophosphate, sodium fluoride; calcitonin, dihydrotachystyrene; growth factors and cytokines such as epidermal growth factor (EGF), platelet-derived growth factor (PDGF), fibroblast growth factors (FGFs), transforming growth factors-b (TGFs-b), transforming growth factor-a (TGF-a), erythropoietin (Epo), insulin-like growth factor-I (IGF-I), insulin-like growth factor-II (IGF-II), interleukin-I (IL-1), interleukin-2 (IL-2), interleukin-6 (IL-6), interleukin-8 (IL-8), tumour necrosis factor-a (TNF-a), tumour necrosis factor-b (TNF-b), interferon-g (INF-g), colony stimulating factors (CSFs); monocyte chemotactic protein, fibroblast stimulating factor 1, histamine, fibrin or fibrinogen, endothelin-1, angiotensin II, collagens, bromocriptin, methyl sergide, methotrexate, carbon tetrachloride, thioacetamide and ethanol; also silver (ions), titanium dioxide, antibiotics and anti-infectives such as, in particular, β-lactam antibiotics, e.g., β-lactamase-sensitive penicillins, such as benzyl penicillins (penicillin G), phenoxymethyl penicillin (penicillin V); β-lactamase-resistant penicillins such as aminopenicillins such as amoxicillin, ampicillin, bacampicillin; acyl aminopenicillins such as mezlocillin, piperacillin; carboxypenicillins, cephalosporins such as, e.g., cefazolin, cefuroxim, cefoxitin, cefotiam, cefaclor, cefadroxil, cefalexin, loracarbef, cefixim, cefuroximaxetil, ceftibuten, cefpodoximproxetil, cefpodoximproxetil; aztreonam, ertrapenem, meropenem; β-lactamase-inhibitors such as sulbactam, sultamicillin tosilat; tetracyclines such as, e.g., doxycycline, minocycline, tetracycline, chlorotetracycline, oxytetracycline; aminoglycosides such as gentamicin, neomycin, streptomycin, tobramycin, amikacin, netilmicin, paromomycin, framycetin, spectinomycin; macrolide antibiotics such as azithromycin, clarithromycin, erythromycin, roxithromycin, spiramycin, josamycin; lincosamides such as, e.g., clindamycin, lincomycin, gyrase inhibitors such as fluoroquinolones such as, e.g., ciprofloxacin, ofloxacin, moxifloxacin, norfloxacin, gatifloxacin, enoxacin, fleroxacin, levofloxacin; quinolones such as pipemidic acid; sulphonamides, trimethoprim, sulphadiazine, sulphalene; glycopeptide antiobiotics such as vancomycin, teicoplanin; polypeptide antibiotics such as polymyxines such as colistin, polymyxin-B, nitroimidazol derivatives such as metronidazol, tinidazol; aminoquinolones such as chloroquin, mefloquin, hydroxychloroquin; biguanides such as, e.g., proguanil; quinine alkaloids and diamino pyrimidines such as, e.g., pyrimethamine; amphenicols such as, e.g., chloramphenicol; rifabutin, dapson, fusidinic acid, fosfomycin, nifuratel, telithromycin, fusafungin, fosfomycin, pentamidine diisethionate, rifampicin, taurolidine, atovaquone, linezolid; virustatics such as aciclovir, ganciclovir, famciclovir, foscamet, inosine (dimepranol-4-acetamidobenzoate), valganciclovir, valaciclovir, cidofovir, brivudin; antiretroviral active principles (nucleoside analogous reverse transcriptase inhibitors and derivates) such as, e.g., lamivudin, zalcitabin, didanosin, zidovudin, tenofovir, stavudin, abacavir; non-nucleoside analogous reverse transcriptase inhibitors: amprenavir, indinavir, saquinavir, lopinavir, ritonavir, nelfinavir; amantadin, ribavirin, zanamivir, oseltamivir and lamivudin, as well as any desired combinations and mixtures thereof.

In preferred exemplary embodiments of the present invention, pharmacologically effective substances incorporated into microcapsules, liposomes, nanocapsules, nanoparticles, micelles, synthetic phospholipids, gas dispersions, emulsions, microemulsions or nanospheres can be used as the coating material.

Suitable solvents can be used as a carrier medium for coating material solutions, suspensions or emulsions. Examples of such solvents include, e.g., methanol, ethanol, n-propanol, isopropanol, butoxydiglycol, butoxy ethanol, butoxy isopropanol, butoxy propanol, n-butyl alcohol, t-butyl alcohol, butylene glycol, butyl octanol, diethylene glycol, dimethoxydiglycol, dimethylether, dipropylene glycol, ethoxydiglycol, ethoxyethanol, ethyl hexane diol, glycol, hexane diol, 1,2,6-hexane triol, hexyl alcohol, hexylene glycol, isobutoxy propanol, isopentyl diol, 3-methoxy butanol, methoxy diglycol, methoxy ethanol, methoxy isopropanol, methoxy methyl butanol, methoxy PEG-10, methylal, methyl hexyl ether, methyl propane diol, neopentyl glycol, PEG-4, PET-6, PET-7, PEG-8, PEG-9, PEG-6-methyl ether, pentylene glycol, PPG-7, PPG-2-buteth-3, PPG-2 butyl ether, PPG-3 butyl ether, PPG-2 methyl ether, PPG-3 methyl ether, PPG-2 propyl ether, propane diol, propylene glycol, propylene glycol butyl ether, propylene glycol propyl ether, tetrahydrofuran, trimethyl hexanol, phenol, benzene, toluene, xylene; and water, if necessary in a mixture with dispersing agents, and/or mixtures of these solvents.

In accordance with exemplary embodiments of the present invention, the surface of the implant to be coated can be coated partially, approximately completely, and/or with multiple layers. A multiple coating can be achieved by performing multiple coating steps, with each step including relative motion between the jacket surface of the printing roller and the surface to be coated in a slip-free manner, wherein drying steps may be applied, if necessary, after each coating step.

It may be preferred to coat an implant with one or several pharmacologically effective substances and, subsequently, with one or several coatings of one or several optional different materials that are capable of modifying the release of the pharmacologically effective substance or substances. Release-modifying materials suitable for this purpose include, for example, cellulose and cellulose derivatives such as hydroxypropyl methylcellulose, hydroxypropyl cellulose, poly(meth)acrylates, carbomers, polyvinyl pyrrolidon, etc.

Preferred exemplary embodiments of the present invention include coated vascular endoprostheses (intraluminal endoprostheses) such as stents, coronary stents, intravascular stents, peripheral stents and the like. These can be biocompatible structures charged in a simple manner in accordance with exemplary embodiments of the present invention, as a result of which, for example, the restenoses which may frequently occur in the case of percutaneous transluminal angioplasty using conventional stents can be prevented.

In certain preferred exemplary embodiments, stents, including stents provided with a carbon-containing surface layer, can be charged with pharmacologically effective substances or mixtures of substances. The stent surfaces can, for example, be equipped with the following active principles for the local suppression of cell adhesion, thrombocyte aggregation, complement activation and/or inflammatory tissue reactions or cell proliferation: heparin, synthetic heparin analogues (e.g., fondaparinux), hirudin, antithrombin III, drotrecogin alpha; fibrinolytics (alteplase, plasmin, lysokinases, factor XIIa, prourokinase, urokinase, anistreplase, streptokinase) thrombocyte aggregation inhibitors (acetyl salicylic acid, ticlopidins, clopidogrel, abciximab, dextrans), corticosteroids (alclometasones, amcinonides, augmented betamethasones, beclomethasones, betamethasones, budesonides, cortisones, clobetasol, clocortolones, desonides, desoximetasones, dexamethasones, flucinolones, fluocinonides, flurandrenolides, flunisolides, fluticasones, halcinonides, halobetasol, hydrocortisones, methyl prednisolones, mometasones, prednicarbates, prednisones, prednisolones, triamcinolones), so-called non-steroidal anti-inflammatory drugs (diclofenac, diflunisal, etodolac, fenoprofen, flurbiprofen, ibuprofen, indomethacin, ketoprofen, ketorolac, meclofenamate, mefenamic acid, meloxicam, nabumethones, naproxen, oxaprozin, piroxicam, salsalates, sulindac, tolmetin, celecoxib, rofecoxib), and/or cytostatics (alkaloids and podophyllum toxins such as vinblastin, vincristin; alkylants such as, e.g., nitroso ureas, nitrogen dichlorodiethyl sulphide analogues; cytotoxic antibiotics such as, e.g., daunorubicin, doxorubicin and other anthracyclins and allied substances, bleomycin, mitomycin; antimetabolites such as folic acid, purine analogues or pyrimidine analogues; paclitaxel, docetaxel, sirolimus; platinum compounds such as, e.g., carboplatin, cisplatin or oxaliplatin; amsacrin, irinotecan, imatinib, topotecan, interferon-alpha 2a, interferon-alpha 2b, hydroxycarbamide, miltefosin, pentostatin, porfimer, aldesleukin, bexarotene, tretinoin; antiandrogens and antiestrogens).

For systemic, cardiological effects, the stents produced in accordance with exemplary embodiments of the present invention can be charged with: antiarrythmics, in particular antiarrhythmics of class I (antiarrhythmics of the quinidine type: quinidine, dysopyramid, ajmalin, prajmalium bitartrate, detajmium bitartrate; antiarrhythmics of the lidocain type: lidocain, mexiletin, phenytoin, tocainid; antiarrhythmics of class IC: propafenon, flecainid (acetate); antiarrhythmics of class II (beta-receptor blockers (metoprolol, esmolol, propranolol, metoprolol, atenolol, oxprenolol), antiarrhythmics of class III (amiodaron, sotalol), antiarrhythmics of class IV (diltiazem, verapamil, gallopamil), other antiarrhythmics such as, e.g., adenosine, orciprenaline, ipratropium bromide; agents for stimulating angiogenesis in the myocardium: vascular endothelial growth factor (VEGF), basic fibroblast growth factor (bFGF), non-viral DNA, viral DNA, endothelial growth factors, FGF-1, FGF-2, VEGF, TGF; antibodies, monoclonal antibodies, anticalines; stem cells, endothelial progenitor cells (EPC). Further exemplary cardiac substances that may be used to charge stents can include, e.g.: digitalis glycosides (acetyl digoxin/methyl digoxin, digitoxin, digoxin), further heart glycosides (ouabain, proscillaridin), antihypertonics (centrally acting anti-adrenergic substances: methyl dopa, imidazoline receptor agonists; calcium channel blockers: of the dihydropyridine type such as nifedipine, nitrendipine; ACE blockers: quinaprilate, cilazapril, moexipril, trandolapril, spirapril, imidapril, trandolapril; angiotensin-II antagonists: candesartan cilexetil, valsartan, telmisartan, olmesartan medoxomil, eprosartan; peripherally effective alpha-receptor blockers: prazosin, urapidil, doxazosin, bunazosin, terazosin, indoramin; vasodilators: dihydralazin, diisopropyl amine dichloroacetate, minoxidil, nitroprussid sodium), other antihypertonics such as indapamid, co-dergocrinmesilate, dihydroergotoxin methane sulphonate, cicletanin, bosentan. Further phosphodiesterase inhibitors (milrinon, enoximon) and antihypotonics, in this case in particular adrenergic and dopaminergic substances (dobutamine, epinephrine, etilefrine, norfenefrine, norepinephrine, oxilofrine, dopamine, midodrine, pholedrine, amexinium methyl), partial adrenoreceptor agonists (dihydroergotamin) and/or other antihypotonics such as, e.g., fludrocortisone.

To increase tissue adhesion, in particular for peripheral stents, components of the extracellular matrix such as, e.g., fibronectin, polylysines, ethylene vinyl acetate, inflammatory cytokines such as, e.g., TGFβ, PDGF, VEGF, bFGF, TNFα, NGF, GM-CSF, IGF-a, IL-1, IL-8, IL-6, growth hormones, as well as adhesive substances such as cyanoacrylates, beryllium or silica can be used can be used as coating materials.

Further substances suitable for this purpose which have a systemic and/or local effect, can include growth factors such as, for example, erythropoetin.

Hormones can also be provided in the stent charges such as, e.g., corticotropins, gonadotropins, somatropin, thyrotrophin, desmopressin, terlipressin, oxytocin, cetrorelix, corticorelin, leuprorelin, triptorelin, gonadorelin, ganirelix, buserelin, nafarelin, goserelin, as well as regulatory peptides such as, e.g., somatostatin and/or octreotide.

For surgical and/or orthopaedic implants, the implants with macroporous surface layers may be used. The pore sizes can be in the range of about 0.1 to 1000 μm, or preferably about 1 to 400 μm, in order to support better integration of the implants by in-growing into the surrounding cell or bone tissue. These implants may be particularly suitable for application and impregnation with a wide variety of different active agents and active agent precursors.

For orthopaedic and non-orthopaedic implants and heart valves, pacemaker electrodes or artificial heart parts, the same active agents listed for the stent applications described above can be used for the local suppression of cell adhesion, thrombocyte aggregation, complement activation and/or inflammatory tissue reaction or cell proliferation.

Moreover, to stimulate tissue growth, in particular for orthopaedic implants, the following active agents can be used for a better implant integration: bone and cartilage stimulating peptides, bone morphogenic proteins (BMPs), in particular recombinant BMPs (recombinant human BMP-2 (rhBMP-2), bisphosphonates (e.g., risedronates, pamidronates, ibandronates, zoledronic acid, clodronic acid, etidronic acid, alendronic acid, tiludronic acid), fluorides (disodium fluorophosphate, sodium fluoride); calcitonin, dihydrotachystyrene, growth factors and cytokines such as, e.g., epidermal growth factor (EGF), platelet-derived growth factor (PDGF), fibroblast growth factors (FGFs), transforming growth factors-b (TGFs-b), transforming growth factor-a (TGF-a), erythropoietin (Epo), insulin-like growth factor-I (IGF-I), insulin-like growth factor-II (IGF-II), interleukin-I (IL-1), interleukin-2 (IL-2), interleukin-6 (IL-6), interleukin-8 (IL-8), tumour necrosis factor-a (TNF-a), tumour necrosis factor-b (TNF-b), interferon-g (INF-g), or colony stimulating factors (CSFs). Further adhesion and integration promoting substances, apart from the inflammatory cytokines already mentioned, that may be used include the monocyte chemotactic protein, fibroblast stimulating factor 1, histamine, fibrin or fibrinogen, endothelin-1, angiotensin II, collagens, bromocriptin, methyl sergide, methotrexate, carbon tetrachloride, thioacetamide, and/or ethanol.

In addition, the implants can also be provided with antibacterial anti-infectious coatings using methods in accordance with the exemplary embodiments of the present invention. The following substances or substance mixtures may be suitable for use as coating material for such applications: silver (ions), titanium dioxide, antibiotics and anti-infectives. Other antibacterial and/or anti-infectious substances that may be used in coating materials include, e.g., β-lactam antibiotics, (β-lactamase-sensitive penicillins, such as benzyl penicillins (penicillin G), phenoxymethyl penicillin (penicillin V); β-lactamase-resistant penicillins such as, e.g., aminopenicillins such as amoxicillin, ampicillin, bacampicillin; acyl aminopenicillins such as, e.g., mezlocillin, piperacillin; carboxypenicillins, cephalosporins (cefazolin, cefuroxim, cefoxitin, cefotiam, cefaclor, cefadroxil, cefalexin, loracarbef, cefixim, cefuroximaxetil, ceftibuten, cefpodoximproxetil, cefpodoximproxetil), or others such as, e.g., aztreonam, ertrapenem, meropenem. Further antibiotics that may be used include, e.g., β-lactamase inhibitors (sulbactam, sultamicillin tosilat), tetracyclines (doxycycline, minocycline, tetracycline, chlorotetracycline, oxytetracycline), aminoglycosides (gentamicin, neomycin, streptomycin, tobramycin, amikacin, netilmicin, paromomycin, framycetin, spectinomycin), macrolide antibiotics (azithromycin, clarithromycin, erythromycin, roxithromycin, spiramycin, josamycin), lincosamides (clindamycin, lincomycin), gyrase inhibitors (fluoroquinolones such as, e.g., ciprofloxacin, ofloxacin, moxifloxacin, norfloxacin, gatifloxacin, enoxacin, fleroxacin, levofloxacin; other quinolones such as pipemidic acid), sulphonamides and trimethoprim (sulphadiazine, sulphalene, trimethoprim), glycopeptide antiobiotics (vancomycin, teicoplanin), polypeptide antibiotics (polymyxines such as colistin, polymyxin-B), nitroimidazol derivatives (metronidazol, tinidazol), aminoquinolones (chloroquin, mefloquin, hydroxychloroquin), biguanides (proguanil), quinine alkaloids and diamino pyrimidines (pyrimethamine), amphenicols (chloramphenicol), and/or other antibiotics (e.g., rifabutin, dapson, fusidinic acid, fosfomycin, nifuratel, telithromycin, fusafungin, fosfomycin, pentamidine diisethionate, rifampicin, taurolidine, atovaquone, linezolid). Still further antibacterial and/or anti-infectious substances that may be used in coating materials include, e.g., virustatics such as aciclovir, ganciclovir, famciclovir, foscarnet, inosine (dimepranol-4-acetamidobenzoate), valganciclovir, valaciclovir, cidofovir, brivudin, as well as santiretroviral active principles (nucleoside analogous reverse transcriptase inhibitors and derivatives): lamivudin, zalcitabin, didanosin, zidovudin, tenofovir, stavudin, abacavir; non-nucleoside analogous reverse transcriptase inhibitors: amprenavir, indinavir, saquinavir, lopinavir, ritonavir, nelfinavir), and other virustatics such as, e.g., amantadin, ribavirin, zanamivir, oseltamivir and lamivudin.

In preferred exemplary embodiments of the present invention, the implants can be suitably modified with respect to their chemical and/or physical properties such as, e.g., hydrophilicity, hydrophobicity, electric conductivity, adhesion or other surface properties, using further agents. Substances suitable for use as coating material for this purpose may include biodegradable or non-degradable polymers. Biodegradable substances that may be used in coating materials include, e.g., collagen, albumin, gelatin, hyaluronic acid, starch, celluloses (methylcellulose, hydroxypropyl cellulose, hydroxypropyl methylcellulose, carboxymethylcellulose phthalate; also casein, dextrans, polysaccharides, fibrinogen, poly(D,L-lactides), poly(D,L-lactide coglycolides), poly(glycolides), poly(hydroxybutylates), poly(alkyl carbonates), poly(orthoesters), polyesters, poly(hydroxyvaleric acid), polydioxanones, poly(ethyl enterephthalates), poly(malatic acid), poly(tartronic acid), polyanhydrides, polyphosphazenes, poly(amino acids), and all their copolymers.

Non-biodegradables substances that may be used in coating materials include, e.g., poly(ethylene vinyl acetates), silicones, acrylic polymers such as polyacrylic acid, polymethyl acrylic acid, polyacrylocynoacrylate; polyethylenes, polypropylenes, polyamides, polyurethanes, poly(ester urethanes), poly(ether urethanes), poly(ester ureas), polyethers such as polyethylene oxide, polypropylene oxide, pluronics, polytetramethylene glycol; vinyl polymers such as polyvinyl pyrrolidones, poly(vinyl alcohols), poly(vinyl acetate phthalate).

Polymers with anionic properties (e.g., alginate, carrageenan, carboxymethylcellulose) or cationic properties (e.g., chitosan, poly-L-lysines etc.) or both properties (e.g., phosphoryl choline) can also be used.

To modify release properties of active agent-containing coated implants made in accordance with the exemplary embodiments of the present invention, specific pH-dependent or temperature-dependent release properties can be produced by applying further polymers. For example. pH-sensitive polymers may be used such as poly(acrylic acid) and derivatives, for example, homopolymers, such as poly(aminocarboxylic acid), poly(acrylic acid), poly(methyl acrylic acid) and their copolymers. Other polymers that may be used include polysaccharides such as, e.g., cellulose acetate phthalate, hydroxypropyl methylcellulose phthalate, hydroxylpropyl methylcellulose succinate, cellulose acetate trimellitate and chitosan. Heat sensitive polymers that may be used include, for example, poly(N-isopropyl acrylamide cosodium acrylate co-n-N-alkyl acrylamide), poly(N-methyl N-n-propyl acrylamide), poly(N-methyl N-isopropyl acrylamide), poly(N-n-propyl methacrylamide), poly(N-isopropyl acrylamide), poly(N,n-diethyl acrylamide), poly(N-isopropyl methacrylamide), poly(N-cyclopropyl acrylamide), poly(N-ethyl acrylamide), poly(N-ethyl methyl acrylamide), poly(N-methyl-N-ethyl acrylamide), poly(N-cyclopropyl acrylamide). Further polymers with thermogel characteristics that may be used include hydroxypropylcellulose, methylcellulose, hydroxypropyl methylcellulose, ethyl hydroxy ethyl-cellulose and pluronics such as F-127, L-122, L-92, L-81, L-61.

If additional coatings of the implants are charged in accordance with certain exemplary embodiments of the present invention, a distinction can consequently be made between physical barriers such as between inert biodegradable substances (poly-1-lysine, fibronectin, chitosan, heparin etc.) and biologically active barriers. The latter can include, e.g., sterically hindered molecules which may be bioactivated physiologically and which can permit the release of active principles and/or their carriers. Enzymes, for example, which mediate the release, can be capable of activating biologically active substances or bind non-active coatings and lead to the exposure of active principles.

The implants coated in accordance with the exemplary embodiments of the present invention may also be charged, in particular applications, with living cells or micro-organisms. These cells can settle in suitable porous surfaces of the implants, and it may then be possible to provide the implant thus colonized with a suitable membrane or membrane-type coating which is permeable to nutrients and/or active principles produced by the cells or micro-organisms, but not permeable to the cells themselves. In this manner it is possible, by using the method and apparatus in accordance with the exemplary embodiments of the present invention, to produce by printing with suspensions of insulin-producing cells, for example, implants containing insulin-producing cells, which, after implanting into the body, can produce and release insulin as a function of the glucose level of the surrounding tissue.

An exemplary embodiment of the method and apparatus of the present invention for applying active agents onto the surface of stents is described below. The details of this exemplary embodiment are intended merely for a further illustration of certain exemplary principles of the present invention, and do not represent a restriction or limitation of the general inventive concept to a particular embodiment.

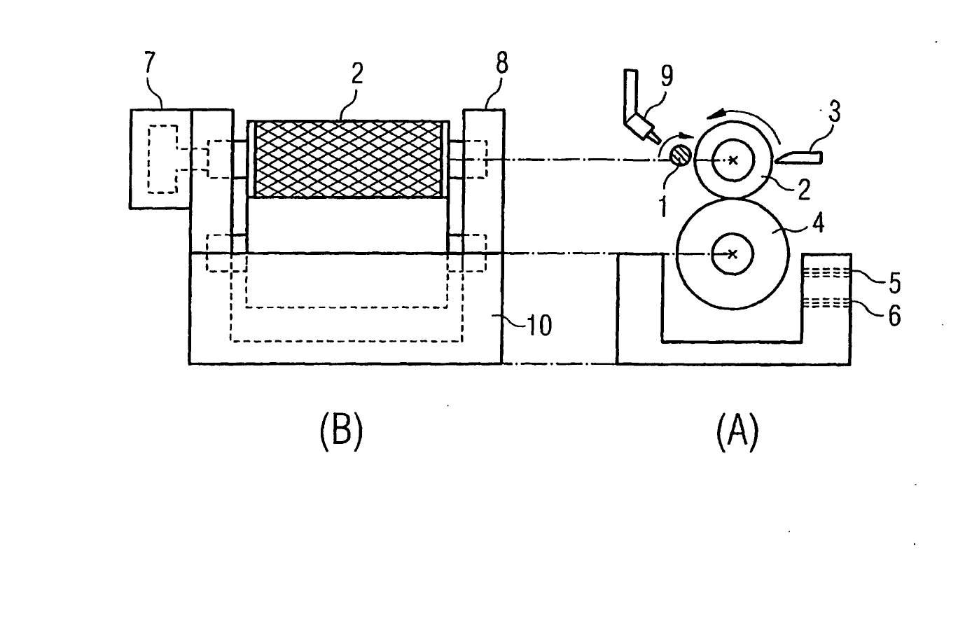

FIGS. 1A and 1B illustrate two views A and B of an apparatus for applying a defined amount of a coating material onto the surface of an implant to be coated using a printing roller.

As shown in FIG. 1A, an implant 1, which in this exemplary embodiment is a cylindrical stent, is arranged on a drive shaft (not shown in FIG. 1A), which is driven in a slip-free manner against a printing roller 2. The printing roller 2 can be a precision anilox/gravure roller with a drive 7, as shown in FIG. 1B, which permits a slip-free movement of the roller 2 with respect to the drive shaft of the stent 1 by providing a rotation of the precision anilox/gravure roller 2 that is opposite to that of the stent 1. The transfer of the coating material from the precision anilox/gravure roller 2 to the stent 1 may take place in a contact-free manner.

As shown in the side view of FIG. 1A, the precision anilox/gravure roller 2 can be in direct contact with a scoop roller 4 which dips at least partially into a storage vessel 10, which is filled with coating material or coating material solution. The movement of the scoop roller 4 may be a rotation that is in a direction opposite to that of the precision anilox/gravure roller 2. The level of the coating material in the storage vessel 10 can be maintained and/or monitored using filling level sensors 5 and 6, as indicated in FIG. 1A, for the determination of the upper and lower level of fill in the storage vessel. The filling level sensors 5, 6 can be, for example, capacitive or conductivity sensors. In automated operation these sensors 5, 6 can permit regular refilling of the storage vessel 10 with coating material, such that the level of the coating material in the storage vessel can be maintained between the levels of fill indicated by the filling level sensors 5, 6 by way of a suitable automated control.

The coating material taken up by the scoop roller 4 may be transferred to the precision anilox/gravure roller 2 by contact, with the recesses in the anilox/gravure roller being filled with coating material. Excess coating material on the precision anilox/gravure roller 2 can be doctored with a doctoring device 3 such as a slitter bar, in order to obtain a defined quantity of coating material pre-indicated by the volume of the recesses of the precision anilox/gravure roller 2. The precision anilox/gravure roller 2 rotates counter-currently in a slip-free manner relative to the stent 1 in such a way that, as provided by the number of rotations, a certain amount of coating material is transferred from the precision anilox/gravure roller 2 to the stent 1 with every complete rotation. In the contact-free process, transfer of the coating material from the precision anilox/gravure roller 2 onto the stent 1 may take place as a result of the adsorption and/or adhesion forces which are intrinsic to the surface properties of the implant to be coated which suffice, due to a suitable arrangement of the printing roller 2 relative to the stent 1 to be coated, to be able to attract the coating material present in the recesses of the jacket surface of the printing roller 2.

As shown in FIG. 1B, the stent 1 may be maintained on a shaft in the shaft bearing blocks 8 and the stent shaft 1 or the anilox/gravure roller 2 can be moved against each other in a slip-free manner via a corresponding precision drive 7.

In the exemplary embodiment of the present invention shown in FIGS. 1A-B, the shaft bearing blocks 8 can be accommodated in a housing in which the storage vessel for active principle 10 is also provided as an integral structural component, resulting in a compact construction.

In one exemplary embodiment of the present invention, a drying device 9, such as an air nozzle, for example, can be provided in spatial vicinity to the stent 1 in order to subject the stent to a flow of heated inert gas in order to evaporate solvent or to dry the coating material. As an alternative or in addition, the drying device 9 can also be a thermal radiation device such as an infrared lamp or the like.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All patents, patent applications and publications referenced herein above are incorporated herein by reference in their entireties.

1-28. (canceled)

29. A method for applying a coating material onto a medical implant, comprising:
charging recesses provided in a surface of a printing roller with a particular amount of the coating material;
arranging the printing roller with respect to the implant such that at least one of adsorption forces or adhesion forces associated with surface properties of the implant attract the coating material; and
applying the coating material present in the recesses to the implant by moving the surface of the printing roller relative to a surface of the implant.

30. The method of claim 29, wherein the charging step comprises filling the recesses with coating material and subsequently removing an excess of the coating material from the surface of the printing roller.

31. The method of claim 29, wherein the charging step comprises:
providing a rotatable scoop roller, wherein at least a portion of the scoop roller is in contact with a reservoir containing the coating material;
rotating the scoop roller to coat a surface of the scoop roller with the coating material; and
transferring the coating material from the scoop roller onto the printing roller.

32. The method of claim 29, wherein at least a portion of the printing roller and at least a portion of the implant are in a direct contact with one another.

33. The method of claim 29, wherein the printing roller and the implant are not in a direct contact with one another.

34. The method of claim 29, wherein the surface of the printing roller relative to the surface of the implant is movable in an essentially slip-free manner.

35. The method of claim 29, wherein the applying step comprises:
rotating the printing roller about a first axis in a first direction; and
rotating the implant about a second axis that is approximately parallel to the first axis in a second direction that is approximately opposite to the first direction.

36. The method of claim 34, wherein the surface of the printing roller is movable relative to the surface of the implant by moving an axis of rotation of the printing roller circumferentially about an axis of rotation of the implant.

37. The method of claim 29, wherein the implant is at least one of a medical implant, a therapeutic implant, a vascular endoprosthesis, a stent, a coronary stent, a peripheral stent, an orthopedic implant, a bone prosthesis, a joint prosthesis, an artificial heart, an artificial heart valve, a pacemaker electrode, a subcutaneous implant, or an intramuscular implant.

38. The method of claim 37, wherein the implant is a carbon-coated stent.

39. The method of claim 29, wherein the printing roller is at least one of a gravure roller, an anilox roller, a rotogravure roller, a ceramic roller, a ceramic anilox roller, a ceramic-coated anilox roller, a flexographic printing roller, an embossing roller, a calendar roller, or a roller having a surface comprising recesses for receiving the coating material.

40. The method of claim 29, wherein the coating material is at least one of a solution, a suspension or an emulsion, wherein the coating material comprises at least one of an active agent or an active agent precursors, and wherein the coating material further comprises a suitable carrier medium.

41. The method of claim 40, wherein the at least one active agent or active agent precursor comprises at least one of a pharmacologically effective substance, a micro-organism, a living organic cell material, a biocompatible inorganic substance, or a biocompatible organic substance.

42. The method of claim 41, wherein the at least one active agent or active agent precursor is incorporated into at least one of a micro-capsule, a liposome, a nanocapsule, a nanoparticle, a micelle, a synthetic phospholipid, a gas dispersion, an emulsion, a micro-emulsion or a nanosphere.

43. The method of claim 29, wherein the surface of the implant is coated with the coating material at least one of partially, approximately completely, or using multiple layers of the coating material.

44. The method of claim 29, wherein the applying step further comprises:
coating the implant with at least one first layer of at least one pharmacologically effective substance; and
subsequently coating the implant with at least one second layer of at least one further material that is capable of modifying the release of the at least one pharmacologically effective substance.

45. An apparatus capable of applying a predetermined amount of a coating material onto a surface of an implant, comprising:
a printing roller having a surface that includes a plurality of recesses capable of holding the predetermined amount of the coating material,
wherein the printing roller is arranged with respect to the implant such that that at least one of suction forces or adsorption forces associated with surface properties of the implant are capable of attracting the coating material present in the recesses, and
wherein the printing roller is movable with respect to the surface of the implant in an approximately slip-free manner.

46. An implant coated with a coating material, produced by a method comprising:
charging recesses formed in a surface of a printing roller with a defined amount of the coating material;
arranging the printing roller with respect to the implant such that at least one of adsorption forces or adhesion forces associated with surface properties of the implant attract the coating material present in the recesses; and
applying the coating material to the implant by moving the surface of the printing roller relative to a surface of the implant.
